(19) United States
(12) Patent Application Publication
(10) Pub. No.: US 2015/0019818 A1
(43) Pub. Date: Jan. 15, 2015

(54) Maintaining Cache Size Proportional to Power Pack Charge

(71) Applicant: LSI Corporation, San Jose, CA (US)

(72) Inventors: Naveen Krishnamurthy, Bangalore (IN); Naresh Madhusudana, Bangalore (IN); Robert L. Sheffield, Longmont, CO (US)

(73) Assignee: LSI Corporation, San Jose, CA (US)

(21) Appl. No.: 13/967,914

(22) Filed: Aug. 15, 2013

(30) Foreign Application Priority Data
Jul. 11, 2013 (IN) 824KOL2013

(51) Int. Cl. G06F 12/08

(52) U.S. Cl. CPC G06F 12/0871; G06F 12/0848
USPC 711/129; 711/143

(57) ABSTRACT

The present disclosure is directed to a method for managing a cache based on a charge of a power source. The method includes the step of determining a charge of the power source at a first time instance. The method also includes the step of designating for write back cache an amount of data in the cache which can be offloaded from the cache based on the charge of the power source at the first time instance. The method also includes the step of designating as write through cache an amount of data remaining in the cache which was not designated as write back cache.

### CROSS-REFERENCE TO RELATED APPLICATIONS

The present application claims the benefit under 35 U.S.C. §119(e) of Indian Application Serial Number 824/KOL/2013 filed Jul. 11, 2013. Said Indian Application Serial Number 824/KOL/2013 filed Jul. 11, 2013 is hereby incorporated by reference.

### FIELD OF THE INVENTION

The present disclosure is directed generally towards caching of data and more particularly to systems and methods for maintaining a cache size proportional to power pack charge.

### BACKGROUND

As cache memory is non-volatile, it requires a power pack such as a battery in order to offload the contents of the cache to a non-volatile memory during power loss. Failure to offload the contents of the controller cache to a non-volatile memory results in the loss of the data in the cache.

Therefore, there exists a need for improved methods and systems for maintaining cache size relative to power pack charge.

### SUMMARY

The present disclosure is directed to a method for managing a cache based on a charge of a power source. The method includes the step of determining a charge of the power source at a first time instance. The method also includes the step of designating for write back cache an amount of data in the cache which can be offloaded from the cache based on the charge of the power source at the first time instance. The method also includes the step of designating as write through cache an amount of data remaining in the cache which was not designated as write back cache.

Additional embodiments are described in the application including the claims. It is to be understood that both the foregoing general description and the following detailed description are exemplary and explanatory only and are not restrictive. Other embodiments of the invention will become apparent.

### BRIEF DESCRIPTION OF THE FIGURES

Other embodiments of the invention will become apparent by reference to the accompanying figures in which:

FIG. 1 shows a diagram of a system for managing a cache;

FIG. 2 shows a rechargeable power source and a cache including data designated for write back mode;

FIG. 3 shows a rechargeable power source and a cache including data designated for write through mode and write back mode;

FIG. 4 shows a rechargeable power source and a cache including data designated for write through mode and write back mode;

FIG. 5 shows a rechargeable power source and a cache including data designated for write back mode;

FIG. 6 shows a rechargeable power source and a cache including data designated for write back mode and write through mode;

FIG. 7 shows a rechargeable power source and a cache including data designated for write back mode and write through mode;

FIG. 8 shows a rechargeable power source and a cache including data designated for write through mode;

FIG. 9 is a flow diagram of a method for managing a cache; and

FIG. 10 is a flow diagram of a method for managing a cache.

### DETAILED DESCRIPTION

Reference will now be made in detail to the subject matter disclosed, which is illustrated in the accompanying drawings. The scope of embodiments of the invention is limited only by the claims; numerous alternatives, modifications, and equivalents are encompassed. For the purpose of clarity, technical material that is known in the technical fields related to the embodiments has not been described in detail to avoid unnecessarily obscuring the description.

As data stored in a cache memory is volatile, it requires a power pack such as a battery in order to offload the contents of the controller cache to a non-volatile memory during power loss. Failure to offload the contents of the controller cache to a non-volatile memory will result in the loss of the cache data which translates into data loss from the host system perspective.

The amount of battery charge required to maintain the data in the controller cache in write back mode depends on the time required to offload the data. The time required to offload the data depends on the amount of data in the controller cache. In some controllers, a fixed amount of write back cache is provided in case the power pack charge is not sufficient to offload the complete write back cache. Some systems set a minimum amount of power pack charge in order to support data in the cache being configured for write back cache. If the power pack is not charged to this minimum amount of charge, the cache policy for all of the data in the cache is designated as write through cache.

In general, this means the cache policy of all the data configured in write back mode will require a change in policy to write through mode when the power pack charge falls below the threshold. The cache policy is changed to write back once the battery is charged to the threshold. As the time required to charge the power pack is significant, overall system performance is impacted when the data is placed in write through mode during the charging period.

In one embodiment, the present disclosure provides a method where the write back cache size is made proportional to the battery capacity. The cache allocated for write back cache is flexible and increases as the battery charge increases, and decreases with decreases in battery charge.

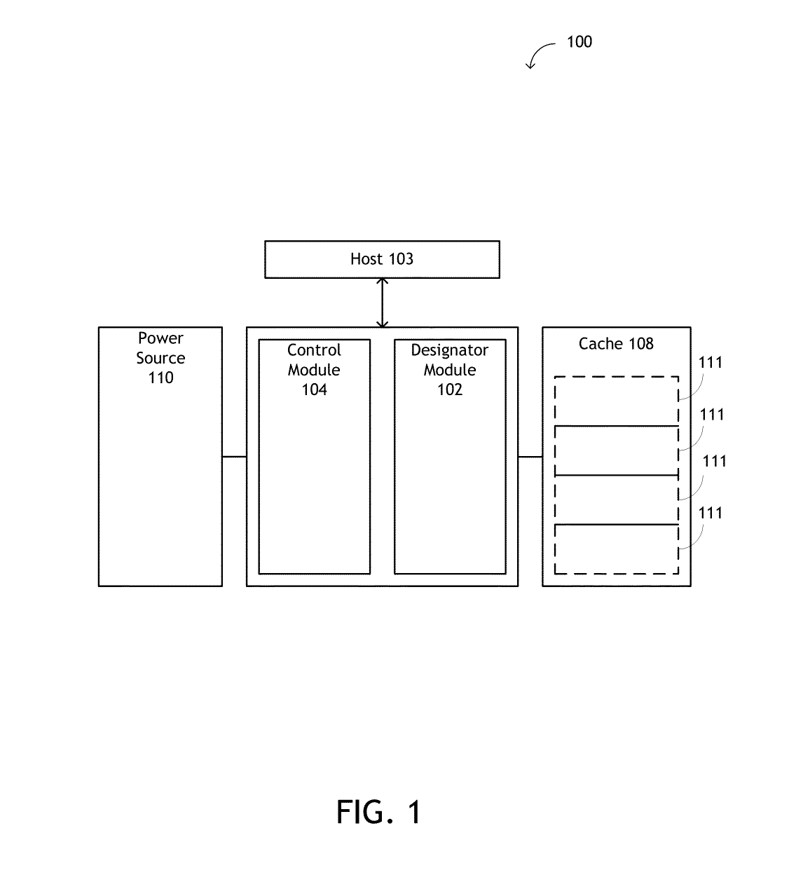

FIG. 1 shows a system 100 including a power source 110, a cache 108 stored on a memory 106, a control module 104 and a designator module 102. The system 100 is in communication with a host 103. The cache 108 is configured for storing data. The data in the cache 108 may be designated as either write back cache or write through cache depending on the charge of power source 110. The control module 104 of the system 100 is configured for determining a charge 116 of the power source 110 at a first time instance and for calculating an amount of data which can be offloaded from the cache 108 when the power source 110 has a predetermined amount of charge. The control module 104 is also configured for dividing the data in the cache 108 into a plurality of data segments 111 having a size equal to the amount of data which can be offloaded from the cache 108 when the power source 110 has the predetermined amount of charge. The system 100 also includes a designator module 102 configured to designate for write back cache a number of data segments 111 which can be offloaded from the cache 108 based on the charge of the power source 110 at the first time instance.

In one embodiment, the designator module 102 is further configured for designating as write through cache a number of data segments 111 remaining in the cache 108 which are not designated as write back cache.

In one embodiment, the system 100 is configured to adjust the amount of write back cache when there is a change in the charge of the power source 110 exceeding a predetermined threshold. The control module 104 detects a change in the charge of the power source 110 exceeding the predetermined threshold and determines a number of data segments 111 which can be offloaded from the cache 108 based on the change in the charge of the power source 110. The designator module 102 is configured to either remove write back cache or write through cache, depending on whether the charge has increased or decreased. When the charge has increased, the designator module 102 is configured to remove the number of data segments 111 which can be offloaded from the cache 108 from the write through cache and add them to the write back cache. When the charge has decreased, the designator module 102 is configured to remove the number of data segments 111 which can be offloaded from the cache 108 from the write back cache and add them to the write through cache.

In one embodiment, the change exceeding a predetermined threshold in the charge of the power source 110 is equal to the amount of charge required to offload one data segment 111 from the cache 108. In another embodiment, the change exceeding a predetermined threshold in the charge of the power source 110 is either greater than or less than the amount of charge required to offload one data segment 111 from the cache 108.

In another embodiment, the system 100 is configured to adjust the amount of write back cache after a predetermined amount of time has elapsed. The control module 104 determines the charge of the power source 110 at a second time instance following the first time instance and determines a number of data segments 111 which can be offloaded from the cache 108 when the charge of the power source 110 at the second time instance has changed by an amount exceeding a predetermined threshold. When the charge has increased from the first time instance to the second time instance, the designator module 102 removes the number of data segments 111 which can be offloaded from the cache 108 from the write through cache and adds them to the write back cache. When the charge has decreased, the designator module 102 removes the number of data segments 111 which can be offloaded from the cache 108 from the write back cache and adds them to the write through cache.

The power source 110 of the system 100 is a back-up or secondary power source in one embodiment and is utilized when a primary power source fails. The power source 110 includes any suitable rechargeable battery or power pack in one embodiment.

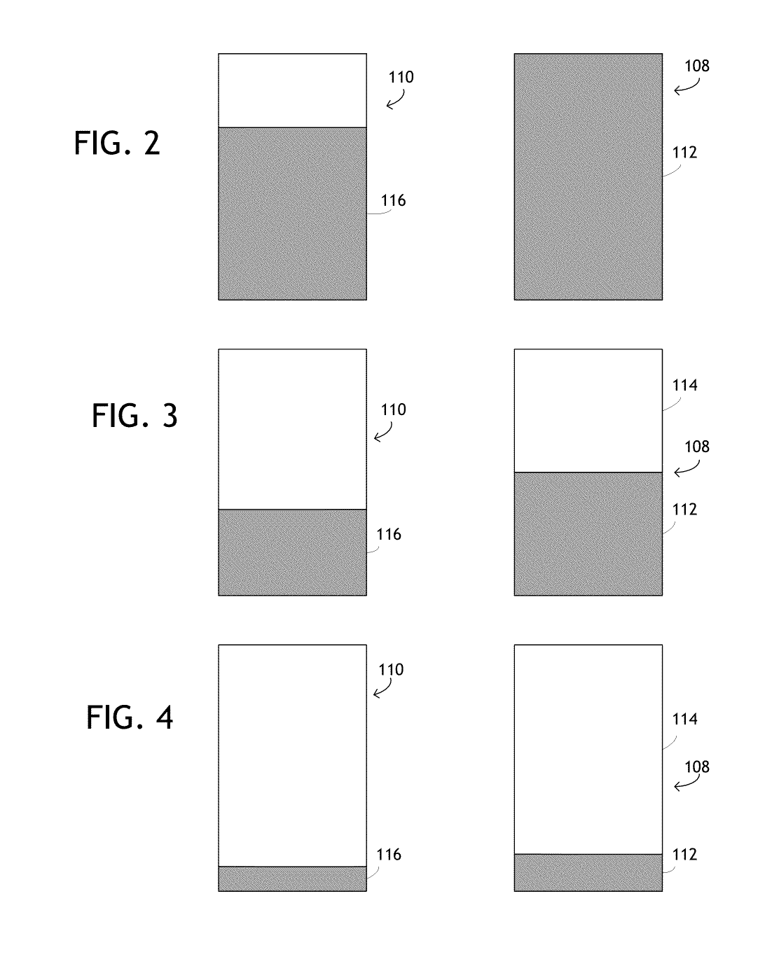

FIGS. 2-4 show how the write back cache size varies according to the battery charge in accordance with embodiments of the disclosure. For example, FIG. 2 shows the power source 110 having a charge 116 of 70%. In the system shown in FIGS. 2-4, a 70% charge 116 is sufficient to support the cache 108 having all data configured as write back cache 112.

FIG. 3 shows the adjustment of the cache 108 when the power source 110 charge 116 has decreased. In FIG. 3, power source 110 has been depleted to a 35% charge 116 which is sufficient to support configuring 50% of the cache as write back cache 112. The data in the cache 108 that is not configured for write back cache 112 is now allocated for write through cache 114.

In FIG. 4, the charge 116 has decreased further to a level of 10%. In this embodiment, a charge 116 of 10% is sufficient to support configuring 14% of the cache 108 as write back cache 112 with the remaining 86% configured for write through cache 114.

FIGS. 2-4 show the write back cache 112 decreasing as the charge 116 decreases, in accordance with embodiments of the invention. The write back cache 112 also increases as the charge 116 increases. In another embodiment, the write back cache 112 both increases and decreases depending on the charge 116.

In addition, the example provided in FIGS. 2-4 shows the power source 110 charge 116 at 70%, 35%, and 10%, with the corresponding write back cache 112 sized at 100%, 50%, and 14%. It is to be understood that the particular levels of charge 116 and the corresponding level of write back cache 112 described herein are merely exemplary. The levels of charge 116 and the corresponding level of write back cache 112 vary depending on the system configuration and other factors.

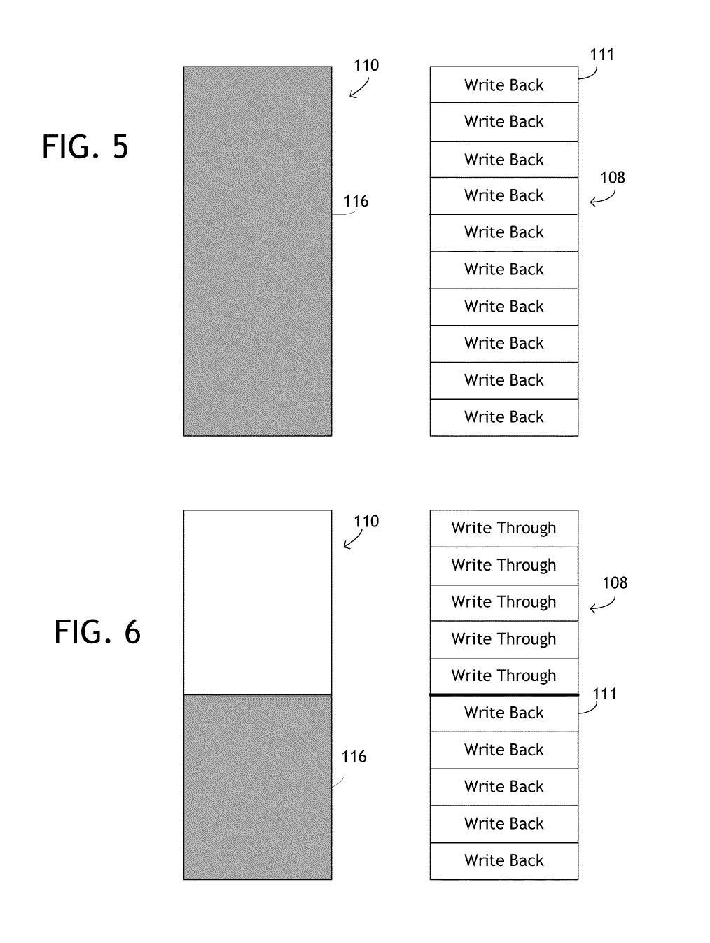

Referring now to the embodiment provided in FIGS. 5-8, another embodiment showing how the write back cache size varies according to the battery charge is provided. In the embodiments shown in FIGS. 5-8, the cache 108 is divided into a plurality of data segments 111. The size of each data segment 111 is equal to the amount of data that can be offloaded from the cache 108 based on a predetermined amount of battery charge 116. For example, if 10% of charge is required to offload 50 MB of data, all of the data in the cache 108 may be divided into data segments 111 having a size of 50 MB each. In the example shown in FIGS. 5-8, the cache 108 holds 500 MB of data which is divided into 10 equally sized data segments 111 of 50 MB each.

FIGS. 5-8 show the adjustment of each data segment 111 in the cache 108 from either write back cache to write through cache, or write through cache to write back cache, depending on changes to the amount of charge 116. In FIG. 5, the charge 116 is 100% which is sufficient to offload all of the 500 MB of data currently in the cache 108, so the policy of all data segments 111 in the cache is write back.

In FIG. 6, the charge 116 of the power source 110 is 50%, which is only sufficient to offload 250 MB of data from the cache 108. As 250 MB of data is equal to five data segments 111, five of the data segments 111 previously designated as write back cache are now designated for write through cache, with the other five data segments 111 remaining as write back cache.

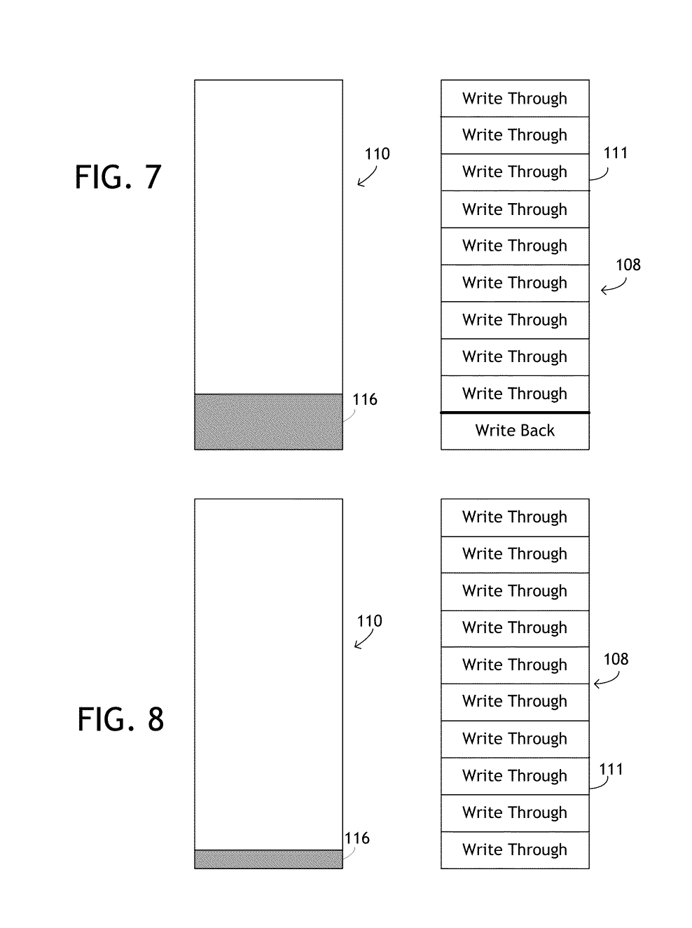

In FIG. 7, the charge 116 of the power source 110 is 15% which is sufficient to offload 75 MB of data, or one full data segment 111. In this embodiment, nine of the ten data segments 111 are designated as write through cache with one of the data segments 111 designated for write back cache.

In FIG. 8, the charge 116 of the power source 110 is 5% which is sufficient to offload 25 MB of data. As the power source 110 lacks sufficient charge 116 to offload a full 50 MB data segment 111, in this embodiment all of the ten data segments 111 are designated as write through cache with none of the data segments 111 designated for write back cache.

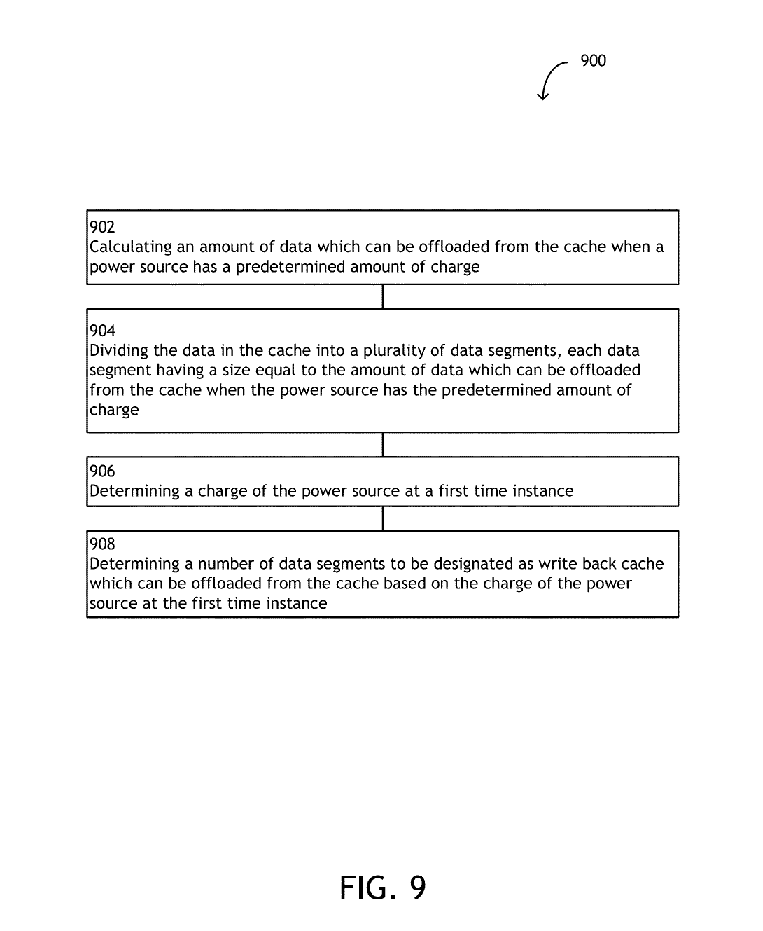

In another embodiment, a method 900 for managing a cache is provided, as shown in FIG. 9. The method 900 includes the step of calculating an amount of data which can be offloaded from the cache when a power source has a predetermined amount of charge 902. The method 900 also includes the step of dividing the data in the cache into a plurality of data segments, each data segment having a size equal to the amount of data which can be offloaded from the cache when the power source has the predetermined amount of charge 904. A further step of the method 900 is to determine a charge of the power source at a first time instance 906. The method also includes the step of determining a number of data segments to be designated as write back cache which can be offloaded from the cache based on the charge of the power source at the first time instance 908.

In one embodiment, the method 900 also includes the step of designating as write through cache a number of data segments remaining in the cache which are not designated as write back cache.

In one embodiment, the method 900 also includes the step of detecting a change in the charge of the power source exceeding a predetermined threshold and determining a number of data segments which can be offloaded from the cache based on the change in the charge of the power source. A further step of the method 900 also includes removing the number of data segments which can be offloaded from the cache based on the change in the charge of the power source from the write through cache and adding them to the write back cache when the charge has increased. The method 900 also includes the step of removing the number of data segments which can be offloaded from the cache based on the change in the charge of the power source from the write back cache and adding them to the write through cache when the charge has decreased.

In another embodiment, the method 900 includes the steps of determining a charge of the power source at a second time instance and determining a number of data segments which can be offloaded from the cache when the charge of the power source at the second time instance has changed by an amount exceeding a predetermined threshold. When the charge has increased from the first time instance to the second time instance, the method 900 includes the step of removing the number of data segments which can be offloaded from the cache based on the change in the charge of the power source from the write through cache and adding them to the write back cache. When the charge has decreased from the first time instance to the second time instance, the method 900 includes the step of removing the number of data segments which can be offloaded from the cache based on the change in the charge of the power source from the write back cache and adding them to the write through cache when the charge has decreased from the first time instance to the second time instance.

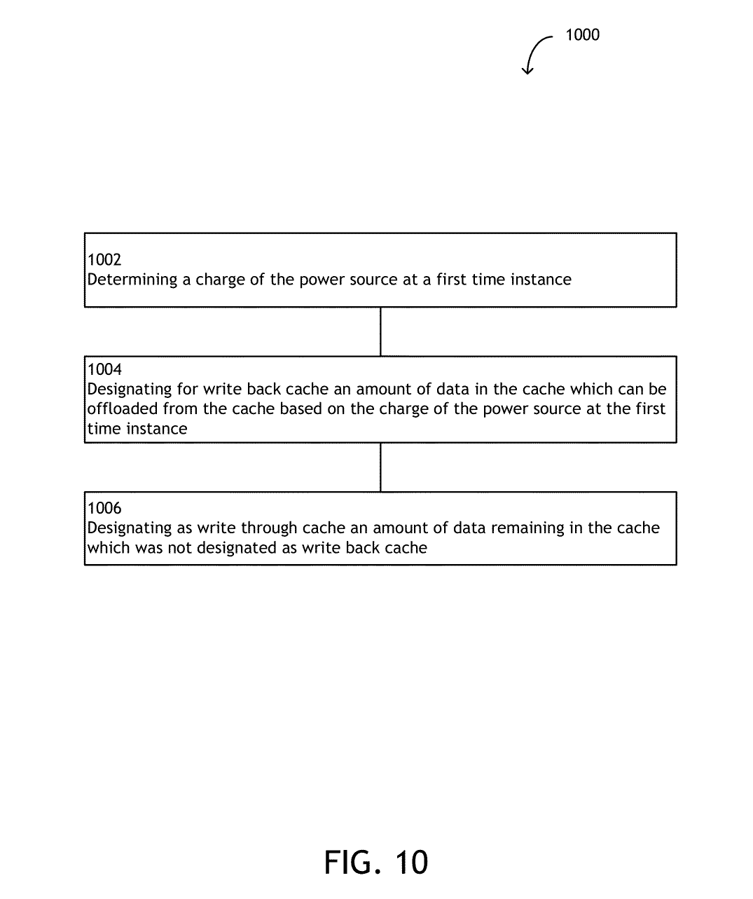

In another embodiment, the present disclosure is directed to a method 1000 for managing a cache based on a charge of a power source as shown in FIG. 10. The method 1000 includes the step of determining a charge of the power source at a first time instance 1002. The method 1000 also includes the step of designating for write back cache an amount of data in the cache which can be offloaded from the cache based on the charge of the power source at the first time instance 1004. The method 1000 also includes the step of designating as write through cache an amount of data remaining in the cache which was not designated as write back cache 1006.

In one embodiment, the method 1000 includes additional steps. For instance, a further step of the method 1000 includes detecting a change in the charge of the power source exceeding a predetermined threshold and determining an amount of data which can be offloaded from the cache based on the change in the charge of the power source. Yet another step of the method 1000 in one embodiment includes removing the amount of data which can be offloaded from the cache based on the change in the charge of the power source from the write through cache and adding the amount of data which can be offloaded from the cache based on the change in the charge of the power source to the write back cache when the charge has increased. If the charge has decreased, the data is removed from the write back cache and added to the write through cache.

The system and methods of the present disclosure support Input/Output capabilities, including instances when the power pack capacity is lower than the threshold to support complete DDR cache for write back policy. The system and methods of the present disclosure also assist with Input/output capabilities over time, including instances when the battery degrades over a period of time. The system and methods of the present disclosure support a flexible and adaptable cache memory size. The system and methods of the present disclosure support performance and assist with Input/output capabilities during times when the battery source is variable, including non-transparent power pack learn cycles in which the power unit gets discharged and charged again. The system and methods of the present disclosure also support cache offload even when partial DDR is used for write back cache.

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method for managing a cache based on a charge of a power source, the method comprising:
determining a charge of the power source at a first time instance;
designating for write back cache an amount of data in the cache which can be offloaded from the cache based on the charge of the power source at the first time instance;
designating as write through cache an amount of data remaining in the cache which was not designated as write back cache.

2. The method as claimed in claim 1, further comprising:
detecting a change in the charge of the power source exceeding a predetermined threshold; and
determining an amount of data which can be offloaded from the cache based on the change in the charge of the power source.

3. The method as claimed in claim 2, further comprising:
removing the amount of data which can be offloaded from the cache based on the change in the charge of the power source from the write through cache and adding the amount of data which can be offloaded from the cache based on the change in the charge of the power source to the write back cache when the charge has increased.

4. The method as claimed in claim 2, further comprising:
removing the amount of data which can be offloaded from the cache based on the change in the charge of the power source from the write back cache and adding the amount of data which can be offloaded from the cache based on the change in the charge of the power source to the write through cache when the charge has decreased.

5. A method for managing a cache, the method comprising:
calculating an amount of data which can be offloaded from the cache when a power source has a predetermined amount of charge;
dividing the data in the cache into a plurality of data segments, each data segment having a size equal to the amount of data which can be offloaded from the cache when the power source has the predetermined amount of charge;
determining a charge of the power source at a first time instance;
determining a number of data segments to be designated as write back cache which can be offloaded from the cache based on the charge of the power source at the first time instance.

6. The method as claimed in claim 5, further comprising:
designating as write through cache a number of data segments remaining in the cache which are not designated as write back cache.

7. The method as claimed in claim 6, further comprising:
detecting a change in the charge of the power source exceeding a predetermined threshold; and
determining a number of data segments which can be offloaded from the cache based on the change in the charge of the power source.

8. The method as claimed in claim 7, further comprising:
removing the number of data segments which can be offloaded from the cache based on the change in the charge of the power source from the write through cache and adding them to the write back cache when the charge has increased.

9. The method as claimed in claim 7, further comprising:
removing the number of data segments which can be offloaded from the cache based on the change in the charge of the power source from the write back cache and adding them to the write through cache when the charge has decreased.

10. The method as claimed in claim 6, further comprising:
determining a charge of the power source at a second time instance;
determining a number of data segments which can be offloaded from the cache when the charge of the power source at the second time instance has changed by an amount exceeding a predetermined threshold.

11. The method as claimed in claim 10, further comprising:
removing the number of data segments which can be offloaded from the cache based on the change in the charge of the power source from the write through cache and adding them to the write back cache when the charge has increased from the first time instance to the second time instance.

12. The method as claimed in claim 10, further comprising:
removing the number of data segments which can be offloaded from the cache based on the change in the charge of the power source from the write back cache and adding them to the write through cache when the charge has decreased from the first time instance to the second time instance.

13. A system, comprising:
a power source;
a cache, the cache stored on a memory, the cache configured for storing data;
a control module configured for determining a charge of the power source at a first time instance, the control module further configured for calculating an amount of data which can be offloaded from the cache when the power source has a predetermined amount of charge, the control module further configured for dividing the data in the cache into a plurality of data segments, each data segment having a size equal to the amount of data which can be offloaded from the cache when the power source has the predetermined amount of charge; and
a designator module, the designator module configured to designate for write back cache a number of data segments which can be offloaded from the cache based on the charge of the battery at a first time instance.

14. The system as claimed in claim 13, wherein the designator module is further configured for designating as write through cache a number of data segments remaining in the cache which are not designated as write back cache.

15. The system as claimed in claim 14, wherein the control module is further configured for detecting a change in the charge of the power source exceeding a predetermined threshold and determining a number of data segments which can be offloaded from the cache based on the change in the charge of the power source.

16. The system as claimed in claim 15, wherein the designator module is further configured for removing the number of data segments which can be offloaded from the cache based on the change in the charge of the power source from the write through cache and adding them to the write back cache when the charge has increased.

17. The system as claimed in claim 15, wherein the designator module is further configured for removing the number of data segments which can be offloaded from the cache based on the change in the charge of the power source from the write back cache and adding them to the write through cache when the charge has decreased.

18. The system as claimed in claim 14, wherein the control module is further configured for determining a charge of the power source at a second time instance and determining a number of data segments which can be offloaded from the cache when the charge of the power source at the second time instance has changed by an amount exceeding a predetermined threshold.

19. The system as claimed in claim 18, wherein the designator module is further configured for removing the number of data segments which can be offloaded from the cache based on the change in the charge of the power source from the write through cache and adding them to the write back cache when the charge has increased from the first time instance to the second time instance.

20. The system as claimed in claim 18, wherein the designator module is further configured for removing the number of data segments which can be offloaded from the cache based on the change in the charge of the power source from the write back cache and adding them to the write through cache when the charge has decreased from the first time instance to the second time instance.
